(19) United States
(12) Patent Application Publication
(10) Pub. No.: US 2002/0113714 A1
(43) Pub. Date: Aug. 22, 2002

(54) IP-addressable light-emitting diode

(76) Inventor: Robert Lopez, San Jose, CA (US)

Correspondence Address: James A. LaBarre, BURNS, DOANE, SWECKER & MATHIS, L.L.P., P.O. Box 1404, Alexandria, VA, 22313-1404, US

(21) Appl. No.: 09/784,052

(22) Filed: Feb. 16, 2001

(51) Int. Cl. G08B 5/22

(52) U.S. Cl. 340/815.45; 340/286.01

(57) ABSTRACT

A simple yet effective technique is provided for visibly identifying the location of computing devices in a networking environment. A unique address is allocated to an LED indicator, and that indicator is associated with a given computing device, or group of neighboring devices. The indicator is mounted on or adjacent the device with which it is associated. In the event that the device needs to be physically accessed, a command is sent to the IP address of its associated LED indicator to thereby provide a visible signal which can be easily recognized, to thereby locate the device of interest. The LED indicator can be activated in one of a plurality of different modes, such as flashing or continuously illuminated, to indicate different states or identify different devices. If the LED is capable of emitting different colors of light, the number of different types of indication is increased.

### FIELD OF THE INVENTION

The present invention is directed to data centers and similar types of facilities which house a large volume of computing equipment, particularly networking devices, and more particularly to a mechanism which enables support personnel to readily identify the location of a particular device that may need to be serviced.

### BACKGROUND OF THE INVENTION

With the continuing expansion of the Internet and other large-scale communication networks, it has become a common practice for many organizations to locate the computing equipment which is used to host resources on such networks in large, warehouse-like facilities, known as data centers or “server farms”. A typical data center may comprise numerous rows of support racks containing the computing devices that provide resources on the network, such as servers, load balancers, switches and the like. Each rack normally contains several such devices, in a stacked configuration. As the profiles of such devices become thinner and thinner, it is possible that a single rack could hold up to 32 individual servers, for example. Consequently, a data center whose space is being efficiently utilized may contain several thousand servers and associated computing devices.

Each device has a physical identity, such as a chassis or CPU serial number, and also a logical Internet Protocol (IP) address through which the device is accessed and controlled. Individual devices, particularly servers, may also be broadly designated by a logical name which can be any reference by which the server may be identified, such as its logical IP address, its host name, or a functional identification. Unlike personal computers, however, networking devices often lack a keyboard or a display with which to query and identify the particular device. Furthermore, serial numbers may be located inside the housing of the device, and therefore be difficult to access or view. In some cases, they may be on a motherboard or network interface card, which could be replaced during the life of the device. Consequently, data centers and remote users typically perceive each device through its logical name because such a name functions as a reliable identifier via which an individual device can be recognized.

When it becomes necessary to physically access a device, for instance due to faulty operation or the need for maintenance, it may only be identified by its logical name, which generally has no nexus to the device's physical location or identification in the data center. This situation can pose a dilemma for data center personnel who need to locate a specific device. Absent a map indicating the device's location, the personnel have no way of locating the device. Even when a device in question is believed to have been located, there is often no way to determine with certainty that the device at hand corresponds to the logical name provided to the personnel.

Some data centers address this problem by maintaining a manual cross-reference chart or map of physical location and logical names for all devices. In other words, the chart or map shows both where the device is located in the data center (for instance by a row and rack number) and the logical name by which remote users access the device. These charts and maps are generally created when new devices are added to the data center, and their respective logical names are established at their initial connection to the communications network. However, such charts and maps can be unreliable at times, because the association between the logical name of the device and the manually-maintained chart or map could be out of date or could contain errors. Devices are often added to a data center, for instance as a website grows. In addition, they can be moved around the data center, or swapped with other devices, and all of these actions can occur without the chart or map being updated. Similarly, data center personnel can inadvertently transpose address numbers when logging the initial or changed location of devices. Consequently, locating a given device for purposes of diagnosing and resolving problems or performing scheduled maintenance can be a difficult, time-consuming and imprecise task. This results, in some instances, of servers becoming “lost” among the thousands of servers in a data center. In other words, data center personnel have no mechanism by which they can positively identify specific servers in the data center. While the percentage of “lost” devices within a data center may be small, the actual number of such inaccessible devices may be in the dozens, or even hundreds.

Accordingly, it is desirable to provide an identification mechanism that facilitates the ability of data center personnel to locate a given computing device within a data center or similar such location that may contain a large number of such devices.

### SUMMARY OF THE INVENTION

To this end, the present invention provides a simple yet effective technique for visibly identifying the location of computing devices in a networking environment. A unique address is allocated to an LED indicator, and that indicator is associated with a given computing device, or group of neighboring devices. Preferably, the indicator is mounted on or adjacent the device with which it is associated. In the event that the device needs to be physically accessed, a command can be sent to the IP address of its associated LED indicator to thereby provide a visible signal which data center personnel can easily recognize, and thereby locate the device of interest.

In one embodiment of the invention, the LED indicator can be activated in one of a plurality of different modes, such as flashing or continuously illuminated, to indicate different states or identify different devices. If the LED is capable of emitting different colors of light, the number of different types of indication can be increased.

These and other features and advantages of the invention are described hereinafter with reference to embodiments of the invention illustrated in the accompanying figures.

### BRIEF DESCRIPTION OF THE DRAWINGS

FIG. 1 is an elevational view of an exemplary row of racks containing computing devices;

FIG. 2 is a view in elevation of one rack of computing devices in accordance with a first embodiment of the present invention;

FIG. 3 is a schematic diagram of an exemplary data center configuration; and

FIG. 4 is a block diagram of an embodiment of an addressable LED.

### DETAILED DESCRIPTION

The present invention is generally directed to a mechanism that readily facilitates the physical location of a computing device within an environment where a multitude of such devices is maintained. An example of such an environment is a data center which houses the infrastructure of Internet web sites. This infrastructure includes computing devices such as servers, load balancers, switches, routers, and the like, as well as the necessary cabling to connect the devices to external communication networks. To provide a thorough understanding of the invention, it is described hereinafter with reference to the particular example of its implementation in a data center, specifically the need to identify and locate servers within a data center. It will be appreciated, however, that the practical applications of the invention are not limited to this particular implementation. Rather, the principles which underlie the invention will find utility in a variety of different environments in which it is desirable to identify a particular computing device from among hundreds or thousands which may be present at a particular location.

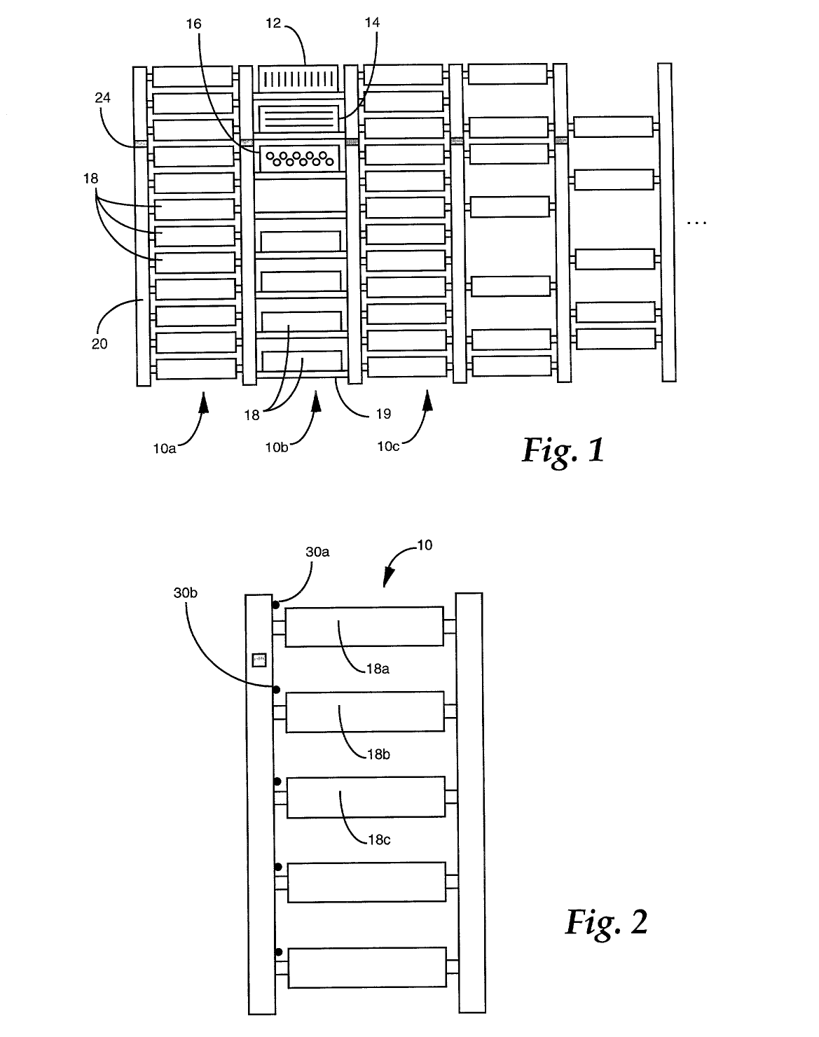

FIG. 1 illustrates an example of the manner in which computing devices may be housed within a facility such as a data center. This example illustrates an elevational view of one row of networking devices in the data center. The networking devices can comprise a number of different types of computing equipment, such as servers, routers, firewalls, load balancers, switches and the like. Other types of equipment, such as data storage devices, may also be housed within the data center. Each of these different items of equipment is supported on a rack, 10a, 10b, 10c. Each rack supports a number of devices in a vertically stacked configuration. Some racks may contain a variety of different types of devices. For example, rack 10b contains a balancer 12, a firewall 14, a switch 16, and a number of servers 18. Other racks may contain only one type of device. For instance, racks 10a and 10c each contain a number of servers 18. Each rack may include a shelf 19 for supporting each of the devices contained in that rack. Alternatively, the devices may be directly affixed to and supported by vertical posts 20 that form the rack. Cabling is provided within each rack and connected to the devices to supply electrical power and conduct I/O communications.

In a large data center, hundreds of such racks may be present, and are typically organized in rows. Each rack 10 can have a label 24 affixed to it, for uniquely identifying the rack. The label may contain a printed number, a printed alphanumeric identifier, a bar code, or any combination thereof for uniquely identifying the rack.

At various times, the computing devices in a data center, particularly the servers, may need to be physically accessed by data center personnel. One such situation, of course, is when the device undergoes a failure, and has to be replaced with a new, functioning unit. In another case, the device may be swapped out for a newer and/or higher powered unit. Even when the device is not being removed from its location, there may be a need to physically access it to perform maintenance. For instance, if the operating system on the device is to be upgraded, it may be necessary to insert a removable disk into the device, or temporarily attach a disk drive unit to it. In another situation, the cabling that is connected to the device may need to be changed, if the site associated with the device is being reconfigured.

While the ability to identify and physically access a computing device is a relatively straightforward task in a small environment which may contain only a few servers, it can be appreciated that it is a much more ominous situation in a data center, where thousands of servers may be present. The data center personnel must know the particular row in which the server is located, the rack within that row that houses the server, and the vertical position of the server on the rack. Even if these items of information are initially recorded when the server is first installed in the data center, there can be no assurance that the data is still correct. For instance, it is a common practice in data centers to rearrange the devices within a given rack, or among multiple racks, as a web site is scaled upwardly or downwardly by adding or removing servers associated with the site. In such a case, manually recorded information regarding the changed location of the server may not be updated. With each such occurrence, the ability to identify and locate a given server becomes more difficult.

In accordance with the present invention, this problem is alleviated by associating a separately addressable indicator with servers and other computing devices, and mounting each indicator in physical proximity to the device with which it is associated. In a preferred implementation of the invention, the indicator comprises a light emitting diode (LED) that is associated with, and can be activated by means of, a unique network address, such as an IP address.

One arrangement of LED indicator units in accordance with the present invention is illustrated in FIG. 2. This figure illustrates one rack 10 containing a number of computing devices, such as servers 18. In this arrangement, an LED indicator 30 is attached to the rack at the location of each mounted server, for example by means of a suitable bracket (not shown). Each LED is paired with one of the servers in the rack, and has a unique IP address which is different from the IP address of its associated server. It therefore becomes possible to identify the server by sending an appropriate signal to the IP address of its associated LED indicator. As a result, when data center personnel receive a request to replace a given non-functioning server, e.g. 18b, they can quickly locate that server, by observing which one of the LED indicators has been activated, in this case LED 30b.

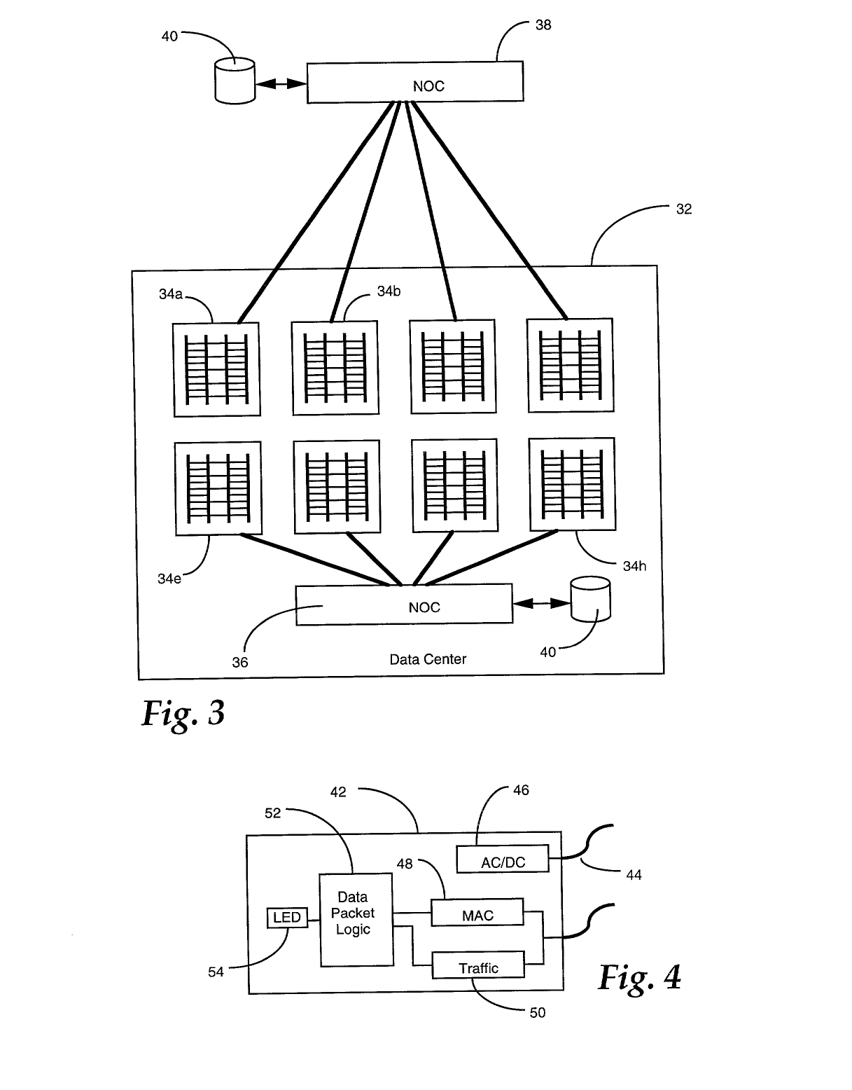

In a typical data center, the servers and other computing devices associated with a given resource, such as a web site, are monitored and controlled from a central location, known as a Network Operations Center (NOC). FIG. 3 is a logical diagram of the manner in which various computing devices in a data center 32 might be associated with respective NOCs. In this example, the data center houses the servers for a number of different web sites 34a-34h. Each web site may have a group of racks associated with it. Each web site is connected to a NOC 36 or 38 that has the responsibility for monitoring the operation of its devices. In the illustrated example, NOC 36 is located within the data center itself, whereas the other NOC 38 is located off-site. Each NOC contains information regarding the computing devices for which it is responsible, particularly their IP addresses. In addition, the NOC may contain other information regarding the devices, such as their logical names, the functions with which they are associated, etc. Preferably, this information is contained within a database 40 that is accessible by personnel at the NOC.

In accordance with the present invention, the IP address of the LED indicator 30 that is associated with a given computing device is also stored as part of the information pertaining to the device, e.g. in the database. If a determination is made that a given device needs to be physically accessed for maintenance or repair purposes, personnel at the appropriate NOC 36 or 38 can send a command to the IP address of the device's associated LED indicator, to activate the indicator. Thus, even though the device may be completely non-functional, data center personnel can positively identify it.

In the embodiment of FIG. 2, a separate LED indicator 30 is provided for each computing device, and the indicators are attached to the racks 10 on which the computing devices are mounted. Alternative arrangements of the devices are also possible. For instance, computing devices other than servers may be relatively small in number, and so it may not be difficult for data center personnel to locate these other types of devices. In that case, it may be desirable to only associate an LED indicator with each server in a rack. In some situations a web site host or data center operator may not want to allocate a separate LED indicator to each computing device or each server. In such a case, it may be preferable to associate an indicator with multiple computing devices. For instance, a single LED indicator might be provided for each rack. In such a case, the LED indicator does not function to uniquely identify a single device. However, identifying the particular rack on which a desired device is located still facilitates the ability of data center personnel to locate that device, by narrowing the search to the devices located on a given rack, rather than having to search throughout several racks or even over a larger portion of the data center.

As an alternative to mounting the LED indicators on the rack themselves, it may be preferable to attach them to the devices with which they are associated. For example, a releaseable mounting system, such as Velcro® strips, might be employed to attach the indicators to the housings of the respective devices. An advantage of this approach lies in the fact that, if a device is moved from one location to another, its associated indicator moves with it.

In order to be addressable on a network, the LED indicators must each have a unique hardware address, also known as a media access control (MAC) address. Currently, these types of addresses are not affiliated with components such as LEDs. Rather, they are assigned to hardware elements such as network interface cards and other devices that have a network port, such as an ethernet port. The MAC address is assigned to the device during the manufacturing process, or by setting jumpers or switches during network installation. One approach to provide unique network addresses to LED indicators, in the implementation of the present invention, is to connect an LED to the network adapter chip on a network interface card.

FIG. 4 provides an illustration of such an arrangement. The LED indicator unit comprises a suitable board 42, such as a silicon wafer, having three protrusions that provide for external connections. One protrusion connects to a power cord 44 that connects to a standard wall outlet, or other suitable power source, at its remote end. At the indicator, the power cord connects to an AC-to-DC converter 46 that provides the appropriate level of power for support chips on the wafer. These chips include functional units for MAC address decoding 48, traffic decoding 50, and data packet logic 52. The address decoder and the traffic decoder are associated with a second protrusion on the wafer, that provides a connector for a network cable, e.g. an RJ45 connector.

An LED 54 is connected to the HIGH pin of a gate in the data packet logic circuit 52. When the gate receives a binary HIGH signal, current flows to the LED, causing it to light up until the gate is no longer receiving the signal. As a result, the LED becomes associated with the network address of the card, and can be controlled by commands transmitted through networking protocols, such as IP or IPX.

The following pseudocode illustrates an example of an IP data packet that can be used to activate the LED 54.

Bind Mac xxxxxxxx xxxxxxxx xxxxxxxx xxxxxxxx

SYNC

CONNECT

START Data Portion of IP Packet

HIGH . . . . . .

NOHIGH

END Data Portion of IP Packet

SYNC

DISCONNECT

In this example, xxx . . . xxx represents the MAC address of the LED indicator. In the “HIGH” command, each period represents one unit of time measurement during which the LED is to remain on.

As an alternative to utilizing a network interface card, other approaches can be employed to provide a unique network address for the LED indicator. For instance, small devices that provide the functionality of a personal computer or a server, known as “wearable computers”, are becoming available. One example of such a wearable computer is the MatchboxPC provided by Tiqit Computers of Menlo Park, Calif. Similar types of network addressable hardware devices can be employed for this purpose as well. By connecting an LED to a suitable terminal of such a device, it can be controlled by means of the network address for that device.

The activation of the LED by means of its IP address can be carried out in different manners to provide different types of information to data center personnel. In one implementation of the invention, a command can be sent to simply turn on the LED continuously to facilitate location of the computing device with which it is associated. The pseudocode example provided above illustrates such an implementation. As a further feature of the invention, different modes of activation can be employed to provide various types of information. For instance, the LED can be on continuously in one mode, and blink in another mode. The following pseudocode illustrates an IP data packet that can be employed for a blinking indication.

Bind Mac xxxxxxxx xxxxxxxx xxxxxxxx xxxxxxxx

SYNC

CONNECT

START Data Portion of IP Packet

HIGH . . . . . .

NOHIGH

HIGH . . . . . .

END Data Portion of IP Packet

SYNC

DISCONNECT

By encoding the HIGH and NOHIGH signals in different combinations, various types of information can be provided with the same LED. For instance, one blink may be used to indicate the first server on a rack, two blinks for the second server, etc.

As another example, some types of LEDs are capable of emitting two different colors of light, such as green and red. Different commands can be sent to such an LED to (1) emit green light continuously, (2) emit red light continuously, (3) emit flashing green light, (4) emit flashing red light, or (5) alternate between green and red. Thus, with a single LED five different items of information can be provided. If the LED is associated with five devices on a rack, for example, the different modes of operating the LED can be used to respectively identify the different devices. Alternatively, if the LED is associated with a single device, five different states regarding the device can be indicated.

In summary, therefore, it can be seen that the present invention provides a simple yet effective technique for visibly identifying the location of computing devices in a networking environment. A unique address is allocated to an LED indicator, and that indicator is associated with a given computing device, or group of devices, which have different IP addresses from the LED indicator. Preferably, the indicator is mounted on or adjacent the device with which it is associated. In the event that the device needs to be physically accessed, a command can be sent to the separate IP address of its associated LED indicator from a remote location, such as a NOC, to directly activate the LED to provide a visible signal which data center personnel can easily recognize, and thereby locate the device of interest.

It will be appreciated by those of ordinary skill in the art that the present invention can be embodied in other specific forms without departing from the spirit or central characteristics thereof. The present disclosed embodiments are therefore considered in all respects to be illustrative, and not restrictive. The scope of the invention is indicated by the appended claims, rather than the foregoing description, and all changes that come within the meaning and range of equivalents thereof are intended to be embraced therein.

What is claimed is:

1. A network-addressable indicator unit for identifying the physical location of a network computing device, comprising:
a hardware device having a communication port for connection to a network and a network address associated therewith which enables said hardware device to be uniquely addressed via said communications port,
a light-emitting device connected to said hardware device so as to be selectively activatable by commands sent to said network address, and
a mounting device for mounting said light-emitting device in physical proximity to a network computing device having a network address different from that of said hardware device.

2. The indicator unit of claim 1 wherein said mounting device enables said light-emitting device to be mounted on the network computing device.

3. The indicator unit of claim 1 wherein said mounting device enables said light-emitting device to be mounted on a structure that supports the network computing device.

4. The indicator unit of claim 1 wherein said light-emitting device is selectively actuatable to emit light of two different colors.

5. The indicator unit of claim 1 wherein said hardware device is a network interface card.

6. The indicator unit of claim 1 wherein said hardware device is a wearable computer.

7. A system for identifying the physical location of network computing devices in an environment containing a multiplicity of such devices, comprising a plurality of network-addressable indicator units that are mounted in physical proximity to respective computing devices with which they are associated, each said indicator unit including a hardware device having a communication port for connection to a network and a network address associated therewith which enables said hardware device to be uniquely addressed via said communications port, and a light-emitting device connected to said hardware device so as to be selectively activatable by commands sent to said network address.

8. The system of claim 7 wherein said indicator units are mounted on the respective computing devices with which they are associated.

9. The system of claim 7 wherein said indicator units are mounted on a structure which supports the respective computing devices with which they are associated.

10. The system of claim 9 wherein said computing devices include servers, and one indicator unit is mounted on said structure for each server supported by that structure.

11. The system of claim 9 wherein said structure comprises plural racks which each support multiple computing devices, and wherein one indicator unit is allocated to each of said servers.

12. The indicator unit of claim 7 wherein said light-emitting device is selectively actuatable to emit light of two different colors.

13. The indicator unit of claim 7 wherein said hardware device is a network interface card.

14. The indicator unit of claim 7 wherein said hardware device is a wearable computer.
